(19) United States
(12) Patent Application Publication
(10) Pub. No.: US 2026/0257777 A1
(43) Pub. Date: Sep. 3, 2026

(54) SOLAR CELL PANEL INCLINATION SUPPORT MEMBER FOR FLOATING SOLAR POWER GENERATION DEVICE

(71) Applicant: SCOTRA CORPORATION, Gunsan-si, Jeollabuk-do (KR)

(72) Inventors: Jong-Mok LEE, Pyeongtaek-si, Gyeonggi-do (KR); Hyun Il JO, Hamyang-gun, Gyeongsangnam-do (KR)

(73) Assignee: SCOTRA CORPORATION, Gunsan-si, Jeollabuk-do (KR)

(21) Appl. No.: 19/165,356

(22) PCT Filed: Mar. 8, 2024
(86) PCT No.: PCT/KR2024/003004

§ 371 Date: Sep. 15, 2025

(30) Foreign Application Priority Data
Mar. 17, 2023 (KR) 10-2023-0035169

(51) Int. Cl. B63B 35/44; H02S 20/00

(52) U.S. Cl. CPC B63B 35/44; H02S 20/00; B63B 2035/4453

(57) ABSTRACT

A solar panel tilt support member for a floating solar power generation apparatus, includes: a lower fixing part elongated in the front-rear direction and fixed to a longitudinal or transverse horizontal frame; an inclined support part extending rearward and obliquely upward from the front end of the lower fixing part to support upper and lower transverse support frames holding the solar panel; and a rear end support part extending upward from the rear end of the lower fixing part and joined with the inclined support part to form a triangular structure with the lower fixing part. A pair of tilt support members are disposed side by side to support the solar panel.

### CROSS-REFERENCE TO PRIOR APPLICATIONS

This Application is a National Stage Patent Application of PCT International Application No. PCT/KR2024/003004 (filed on Mar. 8, 2024), which claims priority to Korean Patent Application No. 10-2023-0035169 (filed on Mar. 17, 2023), which are all hereby incorporated by reference in their entirety.

### BACKGROUND

The present disclosure relates to a floating solar power generation apparatus, and more particularly, to a solar panel tilt support member for a floating solar power generation apparatus which is capable of stably supporting a solar panel in position with simple installation and easily changing the inclination angle of the solar panel in response to the latitude of the installation location.

ecently, regulations to suppress carbon dioxide emissions have been implemented worldwide, and the development of new power generation apparatus that do not emit carbon dioxide is in demand.

As such, a solar power generation apparatus is a representative example of a power generation apparatus that does not emit carbon dioxide and uses clean energy, and floating solar power generation apparatuses, in which solar panels are installed on water surfaces such as rivers, lakes, reservoirs, and dams, are actively being installed in order to secure abundant sunlight and a wide open installation area.

A floating solar power generation apparatus is composed of a plurality of solar panels, and a profile assembly and floats that support the plurality of solar panels so that they are positioned on the water surface.

In a floating solar power generation apparatus according to a related art, as shown in FIG. 1, in a state where a transverse horizontal frame 11 and a longitudinal horizontal frame 12 are cross-coupled, a front-side inclined frame 13a and a rear-side inclined frame 13b are installed forming a triangular structure while being fixed to the longitudinal horizontal frame 12, and solar panels (not shown) are supported by the front-side inclined frame 13a and installed in an inclined state. Here, in order to support the solar panels with wide widths left and right, paired assemblies of the front-side inclined frame 13a and the rear-side inclined frame 13b were installed spaced apart from each other on the left and right sides.

However, since the cumbersome work of using multiple brackets 14, 15a, and 15b to support the solar panels was repeatedly performed, there was a disadvantage in that the work process and time were long. Furthermore, if the cut lengths of the front-side inclined frame 13a installed in pairs on the left and right did not match each other or the cut lengths of the rear-side inclined frames 13b did not match each other, and if the balance was off during the installation process, the inclination angle of the solar panels would be different from the design value, and the work of disassembling and correcting the front-side inclined frame 13a and the rear-side inclined frame 13b again had to be performed. Moreover, if the inclined frames were not level due to a typhoon or high waves, causing the solar panels to be damaged, stable electricity production was impossible.

Furthermore, when the inclination angle of the solar panel needs to be different depending on the latitude of the installation location, the inclination angle of the front-side inclined frame 13a that directly supports the solar panel needs to be changed, but to do so, there was a difficulty in that the entire design had to be changed, such as by making the cut lengths of the front-side inclined frame 13a and the rear-side inclined frame 13b different.

### SUMMARY

Accordingly, the present disclosure has been proposed to solve the problems of the related art as described above, and an object of the present disclosure is to provide a solar panel tilt support member for a floating solar power generation apparatus which is capable of stably supporting a solar panel in position with simple installation and easily changing the inclination angle of the solar panel in response to the latitude of the installation location.

n order to achieve the above object, a solar panel tilt support member according to a technical idea of the present disclosure is a solar panel tilt support member for supporting a solar panel in a floating solar power generation apparatus including the solar panel, a profile assembly configured to support the solar panel to be positioned above a water surface, and a float, characterized in that, in terms of its technical configuration, a lower fixing part formed in an elongated manner in a front-rear direction and fixed to a longitudinal horizontal frame or a transverse horizontal frame of the profile assembly; an inclined support part that extends rearward and obliquely upward in an elongated manner in a form branching from a front end part of the lower fixing part to support an upper transverse support frame which supports an upper end part of the solar panel from a lower side and a lower transverse support frame which supports a lower end part of the solar panel from the lower side, in a crossed configuration from the lower side; and a rear end support part that extends upward in an elongated manner in a form branching from a rear end part of the lower fixing part and then combined with the inclined support part in a form where an upper end part joins with the inclined support part to form a triangular structure together with the lower fixing part and the inclined support part, are formed integrally, such that a pair of solar panel tilt support members are arranged side by side with a spacing between a left side and a right side and support the upper transverse support frame and the lower transverse support frame which support the solar panel.

Here, the solar panel tilt support member may be characterized in that the lower fixing part, the inclined support part and the rear end support part is formed by integrally forming a vertical panel part formed vertically in a flat bar shape, a first horizontal panel part formed horizontally along one end part of the vertical panel part and forming a T-shaped cross-section with the vertical panel part, a second horizontal panel part formed horizontally along another end part of the vertical panel part and forming an inverted T-shaped cross-section with the vertical panel part, and a plurality of first reinforcing ribs protruding from a left side surface and a right side surface of the vertical panel part, respectively, and having one end part and another end part joined to the first horizontal panel part and the second horizontal panel part, respectively, to reinforce strength so that the first horizontal panel part and the second horizontal panel part are not deformed.

In addition, the solar panel tilt support member may be characterized in that the first reinforcing ribs include a straight vertical rib that orthogonally connects the first horizontal panel part and the second horizontal panel part and an X-shaped inclined rib that connects the first horizontal panel part and the second horizontal panel part in an X shape.

In addition, the solar panel tilt support member may be characterized in that the inclined support part is formed in a form that extends further rearward after passing through a point where the rear end support part joins, and the inclined support part is provided with a lower bolt hole near a rear side from a branching point from the lower fixing part so that a lower bolt is fastened to the lower transverse support frame in a state of penetrating the lower bolt hole, and is provided with an upper bolt hole at a rear end part extended from the point where the rear end support part joins so that an upper bolt is fastened to the upper transverse support frame in a state of penetrating the upper bolt hole.

In addition, the solar panel tilt support member may be characterized in that the upper bolt hole of the inclined support part is formed as a long hole having a front-rear inner diameter larger than a left-right inner diameter, so as to allow an angular change of the upper bolt that accompanies a change in installation height of the upper transverse support frame supporting the solar panel for changing an inclination angle of the solar panel.

In addition, the solar panel tilt support member may be characterized by further including a space member installed between the inclined support part and the upper transverse support frame to space the upper transverse support frame upward from the inclined support part in order to increase the inclination angle of the solar panel, and provided with a through hole communicating in correspondence to the upper bolt hole of the inclined support part so that the upper bolt penetrates therethrough.

In addition, the solar panel tilt support member may be characterized in that the space member includes a lower support part which is supported by being fitted outside of the inclined support part, and an upper spacing part which is formed to extend upward from the lower support part and configured to space the upper transverse support frame from the inclined support part between the inclined support part and the upper transverse support frame for support.

In addition, the solar panel tilt support member may be characterized in that the lower support part of the space member includes a pair of lower side walls which are in close contact with a left side surface and a right side surface of the inclined support part, and a lower ceiling which is in contact with an upper surface of the inclined support part by connecting upper end parts of the pair of lower side walls, the upper spacing part of the space member includes a pair of upper side walls extending upward from the lower side walls, and an upper ceiling connecting upper end parts of the pair of upper side walls to contact a lower surface of the upper transverse support frame, and the through holes are respectively formed in the lower ceiling of the lower support part and the upper ceiling of the upper spacing part, and a guide tube configured to guide the upper bolt by connecting the through hole of the lower ceiling and the through hole of the upper ceiling is further formed.

In addition, the solar panel tilt support member may be characterized in that the space member includes a plurality of vertical plate-shaped reinforcing wing parts arranged along a circumferential direction of the guide tube, which are formed by protruding radially from an outer circumferential surface of the guide tube and having an upper end part and a lower end part integrated by contacting the lower ceiling and the upper ceiling.

In addition, the solar panel tilt support member may be characterized in that detachment prevention protrusions which are bent in a direction facing each other so as to be hung on a lower surface edge part of the inclined support part are further formed in lower end parts of the pair of lower side walls belonging to the lower support part of the space member.

In addition, the solar panel tilt support member may be characterized in that the space member is provided with two or more types having different heights of the upper spacing part so as to change the inclination angle of the solar panel and installed selectively on the inclined support part.

In addition, the solar panel tilt support member may be characterized by further including a pair of fastening panel parts which respectively extend downward from a lower end part of a left side surface and a lower end part of a right side surface of the lower fixing part, to face and contact a left side surface and a right side surface of the longitudinal horizontal frame of the profile assembly, respectively, wherein the fastening panel part is provided with a fastening hole for bolt fastening to the longitudinal horizontal frame, and a plurality of fastening panel parts are disposed to be spaced apart along a length direction of the lower fixing part.

In addition, the solar panel tilt support member may be characterized in that an outer surface of the fastening panel part is provided with a plurality of second reinforcing ribs which are formed by protruding along a vertical direction to prevent the fastening panel part from bending.

In addition, the solar panel tilt support member may be characterized in that a step part in a form of an ascending staircase that becomes higher toward rearward so as to selectively support the upper transverse support frame at different heights is formed at the rear end part of the inclined support part, wherein in each step part, an upper bolt additional hole is further formed to allow an upper bolt to penetrate through, and a lower additional bolt hole is further formed corresponding to an upper bolt hole additionally formed in the step part.

In addition, the solar panel tilt support member may be characterized in that an upper surface of the stepped part is formed as a surface more steeply inclined than an upper surface of the inclined support part, and when a plurality of step parts are formed, a step part formed rearward is formed as a surface more steeply inclined than a step part formed forward, so as to correspond to a changed inclination angle of the solar panel.

A solar panel tilt support member for a floating solar power generation apparatus of the present disclosure may stably support a solar panel in position with simple installation and easily change the inclination angle of the solar panel in response to the latitude of the installation location.

In addition, when the solar panel tilt support member for a floating solar power generation apparatus of the present disclosure is configured to have a step part in a form of an ascending staircase, a changed inclination angle may be obtained with one frame, thereby providing an advantage of not shaking even in typhoons or strong waves.

### BRIEF DESCRIPTION OF THE DRAWINGS

FIG. 1 is a reference diagram for explaining prior art.

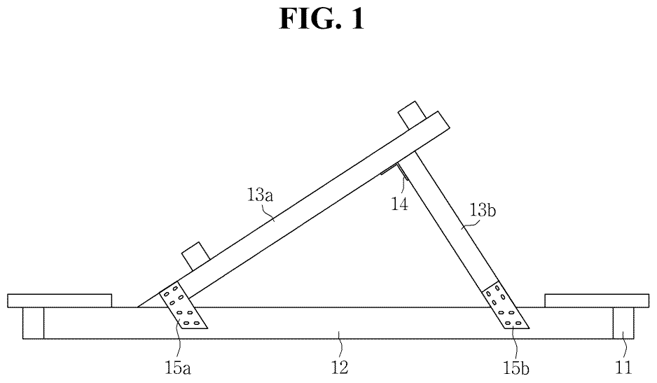

FIG. 2 is a side view of a solar panel tilt support member according to an embodiment of the present disclosure.

FIG. 3 is a perspective view of a solar panel tilt support member according to an embodiment of the present disclosure.

FIG. 4 is a perspective view showing a state in which a solar panel tilt support member is coupled with a longitudinal horizontal frame and a float according to an embodiment of the present disclosure.

FIG. 5 is a side view of a state where an inclination angle of a solar panel is increased by using a space member in a solar panel tilt support member according to an embodiment of the present disclosure.

FIG. 6 is a perspective view of a space member in a solar panel tilt support member according to an embodiment of the present disclosure.

FIG. 7 is a plan view of a space member in a solar panel tilt support member according to an embodiment of the present disclosure.

FIG. 8 is a side view of a state where an inclination angle of a solar panel is further increased by selectively using a deformation space member in a solar panel tilt support member according to an embodiment of the present disclosure.

FIG. 9 is a perspective view of a deformation space member in a solar panel tilt support member according to an embodiment of the present disclosure.

FIG. 10 is a perspective view of a solar panel tilt support member according to a modified embodiment of the present disclosure.

FIG. 11 is a side view of a solar panel tilt support member according to a modified embodiment of the present disclosure.

### EXPLANATION OF SYMBOLS

100: Solar panel tilt support member 110: Lower fixing part
120: Inclined support part 130: Rear end support part
140: Fastening panel part 150: Space member

### DETAILED DESCRIPTION

A solar panel tilt support member according to embodiments of the present disclosure will be described in detail with reference to the accompanying drawings. Since the present disclosure may have various changes and have various forms, specific embodiments are illustrated in the drawings and described in detail in the following. However, it should be understood that the embodiments are not intended to limit the present disclosure to a specific disclosed form and include all modifications, equivalents, and replacements within the idea and technical scope of the present disclosure. In describing each drawing, like reference numerals have been used for like components. In the accompanying drawings, the dimensions of the structures are enlarged than the actual for clarity of the present disclosure, or shown reduced than the actual in order to understand the schematic configuration.

Also, terms such as “first” and “second” may be used to explain various components, but the components should not be limited by the terms. The above terms are used only for the purpose of distinguishing one component from another. For example, a first component may be referred to as a second component, or similarly, the second component may also be referred to as the first component without departing from the scope of the present disclosure. Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

### Embodiments

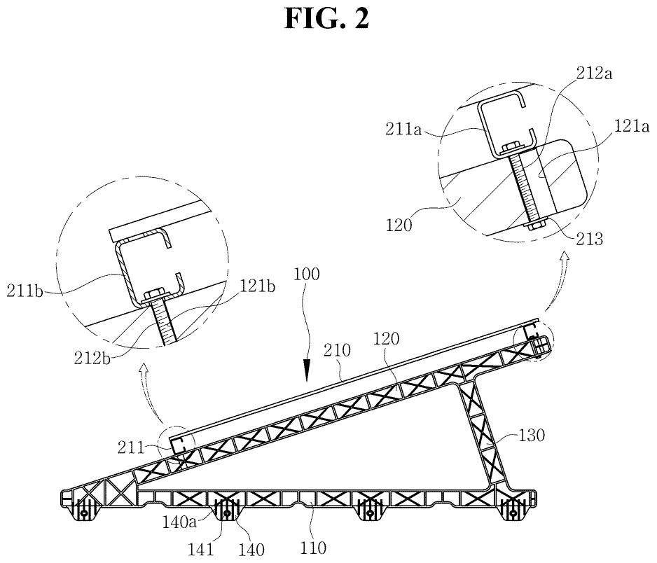

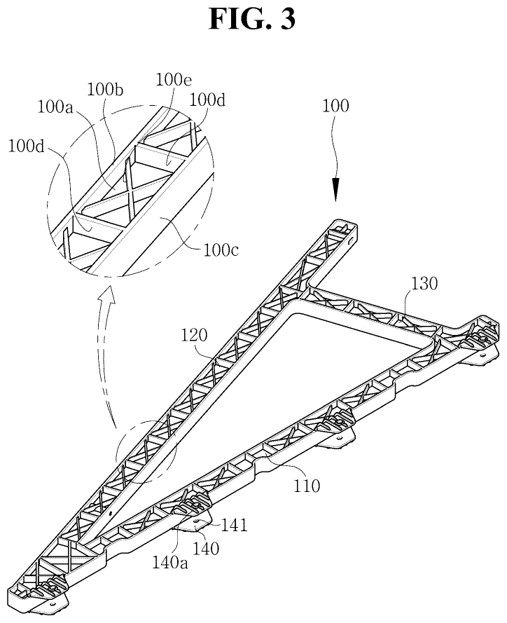

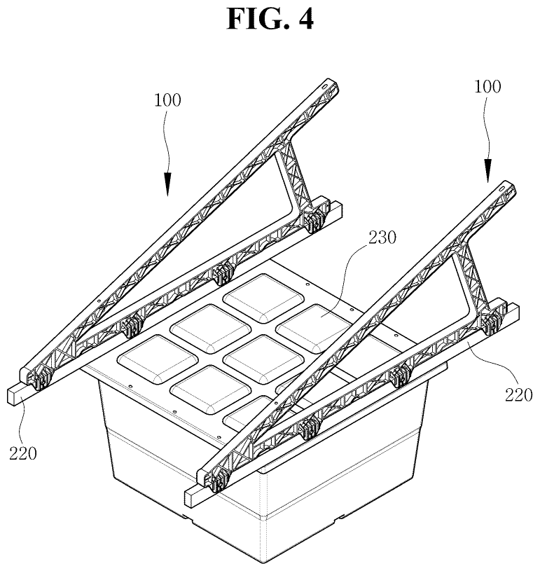

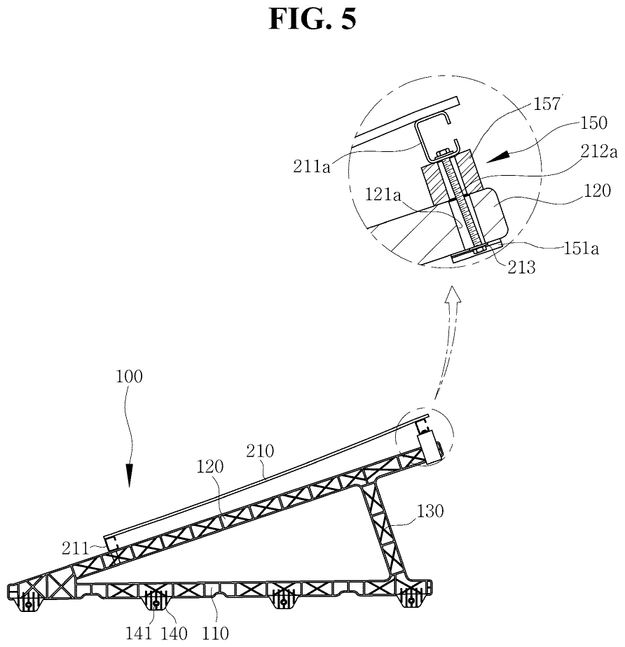

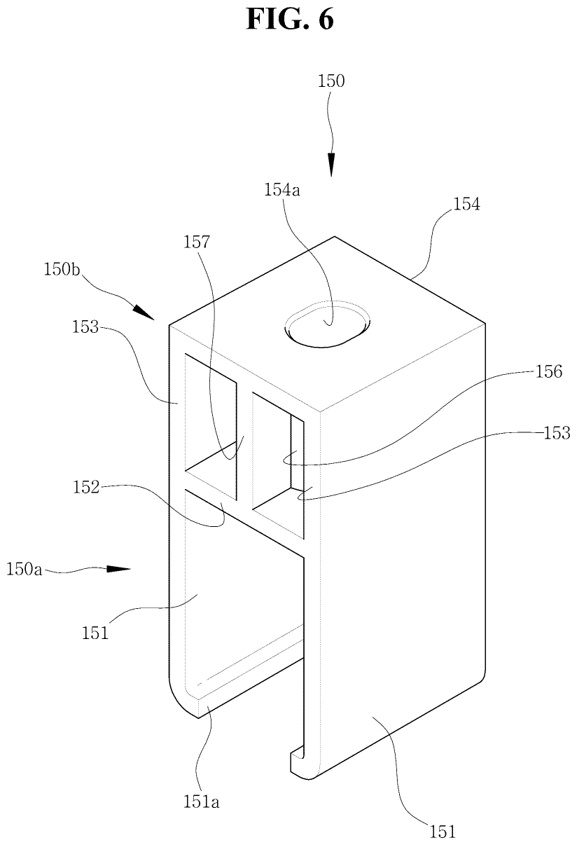

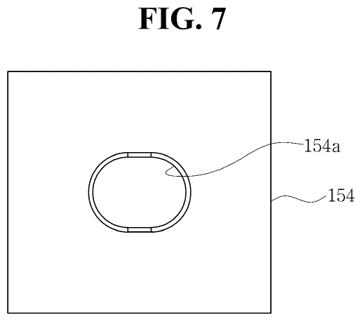

FIG. 2 is a side view of a solar panel tilt support member according to an embodiment of the present disclosure, FIG. 3 is a perspective view of a solar panel tilt support member according to an embodiment of the present disclosure, FIG. 4 is a perspective view showing a state in which a solar panel tilt support member is coupled with a longitudinal horizontal frame and a float according to an embodiment of the present disclosure, FIG. 5 is a side view of a state where an inclination angle of a solar panel is increased by using a space member in a solar panel tilt support member according to an embodiment of the present disclosure, FIG. 6 is a perspective view of a space member in a solar panel tilt support member according to an embodiment of the present disclosure, and FIG. 7 is a plan view of a space member in a solar panel tilt support member according to an embodiment of the present disclosure.

As described above, a solar panel tilt support member 100 according to an embodiment of the present disclosure is for supporting a solar panel 210 in a floating solar power generation apparatus consisting of a solar panel 210, a profile assembly configured to support the solar panel to be positioned above a water surface, and a float, and includes a lower fixing part 110, an inclined support part 120, a rear end support part 130, and a space member 150 as main components. The present disclosure is configured to stably support the solar panel 210 in position simply by combining these main components, and to easily change the support angle of the solar panel 210 in response to the latitude of the installation location.

Hereinafter, the solar panel tilt support member 100 according to an embodiment of the present disclosure will be described in detail with a focus on each of the components.

The lower fixing part 110 is formed in an elongated manner in a front-rear direction and fixed to a longitudinal horizontal frame 220 or a transverse horizontal frame of the profile assembly, and serves to support the inclined support part 120 and the rear end support part 130 from the lower side. Since the lower fixing part 110 is formed in an elongated manner in the front-rear direction, it is more preferable to be fixed in a form supported by contacting along the longitudinal horizontal frame 220 as shown in FIG. 4, which is more stable and sturdy, rather than being fixed in a form supported by crossing the transverse horizontal frame of the profile assembly.

The lower fixing part 110 further includes fastening panel parts 140 which extend downward in a pair from a lower end part of a left side surface and a lower end part of a right side surface, respectively, as shown in FIGS. 2 and 3, to face and contact a left side surface and a right side surface of the longitudinal horizontal frame 220 of the profile assembly. The fastening panel part 140 is formed with a fastening hole 141 for bolt fastening to the longitudinal horizontal frame 220. The plurality of fastening panel parts 140 are disposed to be spaced apart along a length direction of the lower fixing part 110. When the fastening panel parts 140 are formed in pairs on the left and right sides of the lower fixing part 110 in this way, there is an advantage in that the lower fixing part 110 may be properly seated on the longitudinal horizontal frame 220 of the profile assembly using the fastening panel parts 140, and then when the fastening panel part 140 and the longitudinal horizontal frame 220 are fastened with bolts through the fastening holes 141, the lower fixing part 110 is stably fixed while being supported by the longitudinal horizontal frame 220.

Here, a plurality of second reinforcing ribs 140a which are formed by protruding along the vertical direction are provided on the outer surface of the fastening panel part 140. In this way, during the process of fastening the lower fixing part 110 to the longitudinal horizontal frame 220, the relatively thin fastening panel part 140 is reinforced so that it is not easily bent or broken when pressed or impacted by the longitudinal horizontal frame 220.

The inclined support part 120 plays a practical role of supporting the solar panel 210 in an inclined orientation, and has a shape extending rearward and obliquely upward in an elongated manner in a form branching from the front end part of the lower fixing part 110. The inclined support part 120 supports an upper transverse support frame 211a which supports the upper end part of the solar panel 210 from the lower side and a lower transverse support frame 211b which supports the lower end part of the solar panel 210 from the lower side, in a crossed configuration from the lower side. The inclined support part 120 is formed in a form that extends further rearward after passing through a point where the rear end support part 130 joins, and is provided with a lower bolt hole 121b near the rear side from the branching point from the lower fixing part 110 so that a lower bolt 212b is fastened to the lower transverse support frame 211b in a state of penetrating the lower bolt hole 121b, and is provided with an upper bolt hole 121a at the rear end part extended from the point where the rear end support part 130 joins so that an upper bolt 212a is fastened to the upper transverse support frame 211a in a state of penetrating the upper bolt hole 121a.

It should be noted here that the upper bolt hole 121a of the inclined support part 120 is formed as a long hole having a front-rear inner diameter larger than a left-right inner diameter, as shown in FIG. 7. This is to allow for an angular change of the upper bolt 212a that accompanies the change in installation height of the upper transverse support frame 211a supporting the solar panel 210 for changing the inclination angle of the solar panel 210 so that the floating solar power generation apparatus may effectively generate power according to the latitude of the installation location, as shown in the enlarged parts of FIGS. 2, 5, and 8, respectively. For reference, the inclination angle of the solar panel 210 is shown as becoming higher from FIGS. 2 to 5 and 8, and as the inclination angle of the solar panel 210 changes in this way, the angle change of the upper bolt 212a is inevitable.

The rear end support part 130 plays a role in stably supporting the rear end part of the inclined support part 120. To this end, the rear end support part 130 extends upward in an elongated manner in a form branching from the rear end part of the lower fixing part 110 and then combined with the inclined support part 120 in a form where the upper end part joins with the inclined support part 120. The rear end support part 130 is integrated with the lower fixing part 110 and the inclined support part 120 to form a structurally very stable triangular structure. At this time, the rear end support part 130 is integrated in a form orthogonal or nearly orthogonal to the inclined support part 120.

All of the lower fixing part 110, the inclined support part 120, and the rear end support part 130 described above are formed based on a body in which a vertical panel part 100a, a first horizontal panel part 100b, a second horizontal panel part 100c, and first reinforcing ribs 100d and 100e are integrally formed, as shown in the enlarged part of FIG. 3. The vertical panel part 100a is formed vertically in a flat bar shape. The first horizontal panel part 100b is formed horizontally along one end part of the vertical panel part 100a to form a T-shaped cross-section with the vertical panel part 100a. The second horizontal panel part 100c is formed horizontally along the other end of the vertical panel part 100a to form an inverted T-shaped cross-section with the vertical panel part 100a. The first reinforcing ribs 100d and 100e protrude from the left side surface and right side surface of the vertical panel part 100a, respectively, and have one end part and the other end part joined to the first horizontal panel part 100b and the second horizontal panel part 100c, respectively, to reinforce the strength so that the first horizontal panel part 100b and the second horizontal panel part 100c are not deformed. To this end, the first reinforcing ribs 100d and 100e includes a straight vertical rib 100d that orthogonally connects the first horizontal panel part 100b and the second horizontal panel part 100c, and an X-shaped inclined rib 100e that connects the first horizontal panel part 100b and the second horizontal panel part 100c in an X shape. The straight vertical rib 100d is effective in preventing deformation that may occur when a load is applied in a orthogonal direction between the first horizontal panel part 100b and the second horizontal panel part 100c, and the X-shaped inclined rib 100e is effective in preventing deformation that may occur when a load is applied in an oblique direction between the first horizontal panel part 100b and the second horizontal panel part 100c.

The lower fixing part 110, the inclined support part 120, and the rear end support part 130 are made of synthetic resin, which is a lightweight material that is advantageous in molding compared to metal and may minimize weight. In addition, in terms of form, the body formed of the vertical panel part 100a, the first horizontal panel part 100b, the second horizontal panel part 100c, and the first reinforcing ribs 100d and 100e is lightweight while still ensuring sufficient strength to support the solar panel 210.

As shown in FIG. 4, the solar panel tilt support members according to the embodiment of the present disclosure are installed to be spaced apart from each other on left and right sides and forming a pair side by side to support the upper transverse support frame 211a and the lower transverse support frame 211b which support the solar panel 210.

The space member 150 is included as a separate entity, unlike the integrally formed lower fixing part 110, inclined support part 120, and rear end support part 130 as shown in FIGS. 5 to 7, and serves to space the upper transverse support frame 211a upward from the inclined support part 120 in order to further increase the inclination angle of the solar panel 210. The space member 150 consists of a lower support part 150a which is configured to space the upper transverse support frame 211a upward from the inclined support part 120 and is supported by being fitted outside of the inclined support part 120 in a state of being positioned between the inclined support part 120 and the upper transverse support frame 211a, and an upper spacing part 150b which is formed to extend upward from the lower support part 150a and configured to space the upper transverse support frame 211a from the inclined support part 120 between the inclined support part 120 and the upper transverse support frame 211a for support.

As shown in FIG. 6, the lower support part 150a of the space member 150 consists of a pair of lower side walls 151 which are in close contact with the left side surface and right side surface of the inclined support part 120, and a lower ceiling 152 which is in contact with the upper surface of the inclined support part 120 by connecting the upper end parts of the pair of lower side walls 151. The upper spacing part 150b consists of a pair of upper side walls 153 extending upward from the lower side walls 151, and an upper ceiling 154 connecting the upper end parts of the pair of upper side walls 153 to contact the lower surface of the upper transverse support frame 211a. In each of the lower ceiling 152 of the lower support part 150a and the upper ceiling 154 of the upper spacing part 150b, a through hole 154a communicating in correspondence to the upper bolt hole 121a of the inclined support part 120 so that the upper bolt 212a penetrates therethrough is formed.

In addition, the upper spacing part 150b of the space member 150 is further provided with a guide tube 156 configured to guide the upper bolt 212a by connecting the through hole 154a of the lower ceiling 152 and the through hole 154a of the upper ceiling 156. When the guide tube 156 is further formed, the upper bolt 212a may be smoothly penetrated through the through hole 154a formed in the lower ceiling 152 of the lower support part 150a and the upper ceiling 154 of the upper spacing part 150b without any problems. Furthermore, a plurality of vertical plate-shaped reinforcing wing parts 157 are arranged along the circumferential direction of the guide tube 156, which are formed by protruding radially from the outer circumferential surface of the guide tube 156 and having the upper end part and lower end part integrated by contacting the lower ceiling 152 and the upper ceiling 154. In this way, the space member 150 may have high strength while being a lightweight member made of synthetic resin by virtue of the configuration including the guide tube 156 and the reinforcing wing parts 157.

In addition, the lower end parts of the pair of lower side walls 151 belonging to the lower support part 150a of the space member 150 are further formed with detachment prevention protrusions 151a which are bent in a direction facing each other so as to be hung on the lower surface of the inclined support part 120. In the case of providing the detachment prevention protrusions 151a in this way, the space member 150 may be primarily prevented from being separated upward while in a state of being coupled to the inclined support part 120. Furthermore, the lower support part 150a may be simply fitted and coupled to the inclined support part 120 by slightly spreading the pair of lower side walls 151 made of an elastic synthetic resin material.

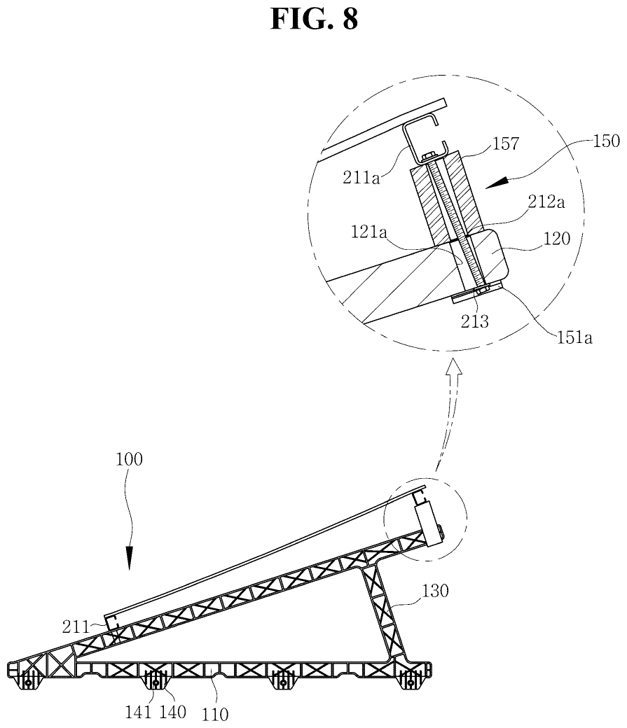

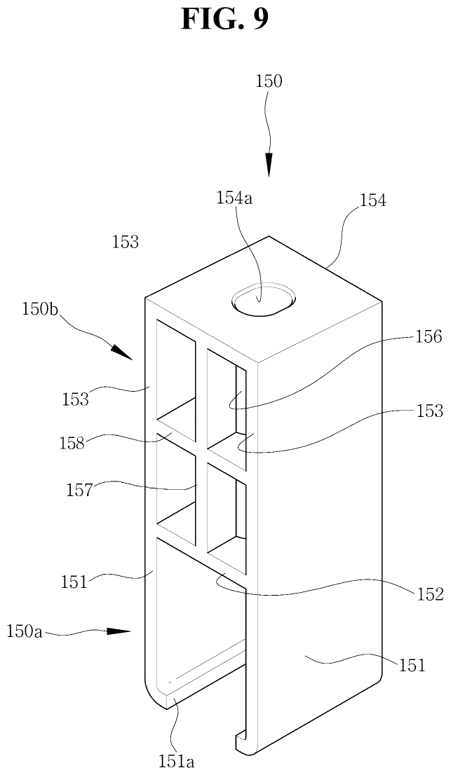

It is preferable that the space member 150 be provided with two or more types having different heights of the upper spacing part 150b so as to change the inclination angle of the solar panel 210 and installed selectively on the inclined support part 120. As a result, it is possible to support the solar panel 210 with the inclination angle adjusted as needed, as in FIG. 5 and FIG. 8, where the space member 150 is used, compared to FIG. 2, where the space member 150 is not used. FIG. 8 and FIG. 9 illustrate a space member 150 having a relatively higher height of the upper spacing part 150b compared to the space members 150 illustrated in FIGS. 5 to 7. As the height of the upper spacing part 150b of the space member 150 increases in this way, the vertical length of the guide tube 156 and the vertical length of the reinforcing wing part 157 also increase, so it is preferable to further form an intermediate reinforcing part 158 in the shape of a horizontal panel that is integrated in a form that intersects and contacts the guide tube 156 and the reinforcing wing part 157 at a midpoint between the lower ceiling 152 and the upper ceiling 154.

According to the configuration having the space member 150 as described above, simply by inserting and installing the space member 150 into the inclined support part 120, the inclination angle of the solar panel 210 may be easily changed in accordance with the latitude of the installation location.

Hereinafter, a solar panel tilt support member according to a modified embodiment of the present disclosure will be described.

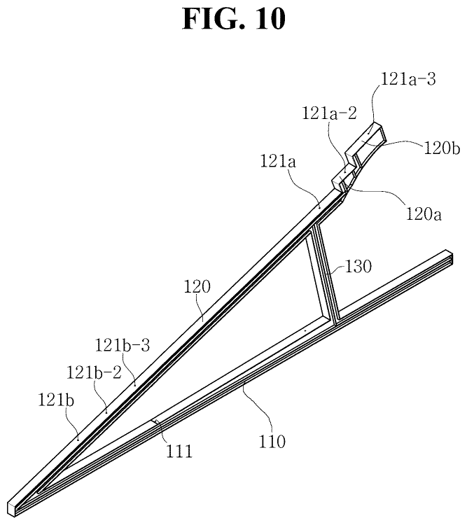

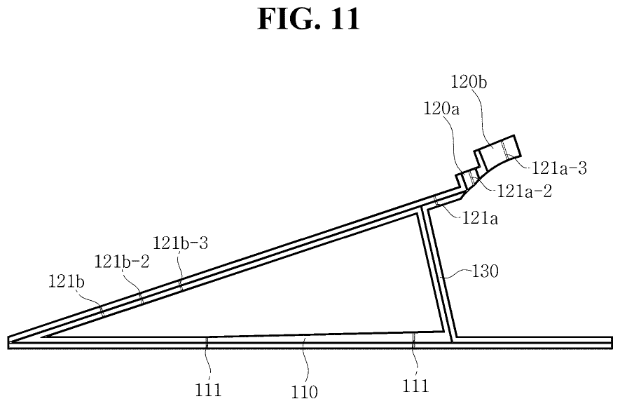

FIG. 10 is a perspective view of a solar panel tilt support member according to a modified embodiment of the present disclosure, and FIG. 11 is a side view of a solar panel tilt support member according to a modified embodiment of the present disclosure.

As illustrated, the solar panel tilt support member according to the modified embodiment of the present disclosure is characterized in that, unlike the previous non-modified embodiment, it may support the upper transverse support frame 211a in response to a change in the inclination angle of the solar panel 210 without having a separate space member 150.

To this end, step parts 120a and 120b in a form of an ascending staircase that becomes higher toward rearward so as to selectively support the upper transverse support frame 211a at different heights is formed at the rear end part of the inclined support part 120. An upper additional bolt hole 121a-2, 121a-3 is further formed in each step part 120a, 120b to allow an upper bolt 212a to penetrate through, and a plurality of lower additional bolt hole 121b-2 and 121b-3 are further formed corresponding to the upper additional bolt holes 121a-2 and 121a-3 at the front end part of the inclined support part 120.

Here, the upper surface of the stepped part 120a, 120b is formed as a surface more steeply inclined than the upper surface of the inclined support part 120, and when a plurality of step parts 120a and 120b are formed, a step part formed rearward is formed as a surface more steeply inclined than a step part formed forward, so as to correspond to a changed inclination angle of the solar panel 210.

Although preferred embodiments of the present disclosure have been described above, various changes, modifications and equivalents may be used in the present disclosure. It is clear that the present disclosure may be equally applied by appropriately modifying the above embodiments. Accordingly, the above description is not intended to limit the scope of the present disclosure, which is defined by the limits of the appended claims.

1. A solar panel tilt support member for supporting a solar panel in a floating solar power generation apparatus comprising the solar panel, a profile assembly configured to support the solar panel to be positioned above a water surface, and a float, wherein
a lower fixing part formed in an elongated manner in a front-rear direction and fixed to a longitudinal horizontal frame or a transverse horizontal frame of the profile assembly;
an inclined support part that extends rearward and obliquely upward in an elongated manner in a form branching from a front end part of the lower fixing part to support an upper transverse support frame which supports an upper end part of the solar panel from a lower side and a lower transverse support frame which supports a lower end part of the solar panel from the lower side, in a crossed configuration from the lower side; and
a rear end support part that extends upward in an elongated manner in a form branching from a rear end part of the lower fixing part and then combined with the inclined support part in a form where an upper end part joins with the inclined support part to form a triangular structure together with the lower fixing part and the inclined support part, are formed integrally,
such that a pair of solar panel tilt support members are arranged side by side with a spacing between a left side and a right side and support the upper transverse support frame and the lower transverse support frame which support the solar panel.

2. The solar panel tilt support member of claim 1, wherein the lower fixing part, the inclined support part and the rear end support part are formed by integrally forming a vertical panel part formed vertically in a flat bar shape, a first horizontal panel part formed horizontally along one end part of the vertical panel part and forming a T-shaped cross-section with the vertical panel part, a second horizontal panel part formed horizontally along another end part of the vertical panel part and forming an inverted T-shaped cross-section with the vertical panel part, and a plurality of first reinforcing ribs protruding from a left side surface and a right side surface of the vertical panel part, respectively, and having one end part and another end part joined to the first horizontal panel part and the second horizontal panel part, respectively, to reinforce strength so that the first horizontal panel part and the second horizontal panel part are not deformed.

3. The solar panel tilt support member of claim 2, wherein the first reinforcing ribs comprise a straight vertical rib that orthogonally connects the first horizontal panel part and the second horizontal panel part and an X-shaped inclined rib that connects the first horizontal panel part and the second horizontal panel part in an X shape.

4. The solar panel tilt support member of claim 1, wherein the inclined support part is formed in a form that extends further rearward after passing through a point where the rear end support part joins, and
the inclined support part is provided with a lower bolt hole near a rear side from a branching point from the lower fixing part so that a lower bolt is fastened to the lower transverse support frame in a state of penetrating the lower bolt hole, and is provided with an upper bolt hole at a rear end part extended from the point where the rear end support part joins so that an upper bolt is fastened to the upper transverse support frame in a state of penetrating the upper bolt hole.

5. The solar panel tilt support member of claim 4, wherein the upper bolt hole of the inclined support part is formed as a long hole having a front-rear inner diameter larger than a left-right inner diameter, so as to allow an angular change of the upper bolt that accompanies a change in installation height of the upper transverse support frame supporting the solar panel for changing an inclination angle of the solar panel.

6. The solar panel tilt support member of claim 5, further comprising a space member installed between the inclined support part and the upper transverse support frame to space the upper transverse support frame upward from the inclined support part in order to increase the inclination angle of the solar panel, and provided with a through hole communicating in correspondence to the upper bolt hole of the inclined support part so that the upper bolt penetrates therethrough.

7. The solar panel tilt support member of claim 6, wherein the space member comprises a lower support part which is supported by being fitted outside of the inclined support part, and an upper spacing part which is formed to extend upward from the lower support part and configured to space the upper transverse support frame from the inclined support part between the inclined support part and the upper transverse support frame for support.

8. The solar panel tilt support member of claim 7, wherein the lower support part of the space member comprises a pair of lower side walls which are in close contact with a left side surface and a right side surface of the inclined support part, and a lower ceiling which is in contact with an upper surface of the inclined support part by connecting upper end parts of the pair of lower side walls,
the upper spacing part of the space member comprises a pair of upper side walls extending upward from the lower side walls, and an upper ceiling connecting upper end parts of the pair of upper side walls to contact a lower surface of the upper transverse support frame, and
the through holes are respectively formed in the lower ceiling of the lower support part and the upper ceiling of the upper spacing part, and a guide tube configured to guide the upper bolt by connecting the through hole of the lower ceiling and the through hole of the upper ceiling is further formed.

9. The solar panel tilt support member of claim 8, wherein the space member comprises a plurality of vertical plate-shaped reinforcing wing parts arranged along a circumferential direction of the guide tube, which are formed by protruding radially from an outer circumferential surface of the guide tube and having an upper end part and a lower end part integrated by contacting the lower ceiling and the upper ceiling.

10. The solar panel tilt support member of claim 8, wherein detachment prevention protrusions which are bent in a direction facing each other so as to be hung on a lower surface edge part of the inclined support part are further formed in lower end parts of the pair of lower side walls belonging to the lower support part of the space member.

11. The solar panel tilt support member of claim 8, wherein the space member is provided with two or more types having different heights of the upper spacing part so as to change the inclination angle of the solar panel and installed selectively on the inclined support part.

12. The solar panel tilt support member of claim 1, further comprising:
a pair of fastening panel parts which respectively extend downward from a lower end part of a left side surface and a lower end part of a right side surface of the lower fixing part, to face and contact a left side surface and a right side surface of the longitudinal horizontal frame of the profile assembly, respectively,
wherein the fastening panel part is provided with a fastening hole for bolt fastening to the longitudinal horizontal frame, and a plurality of fastening panel parts are disposed to be spaced apart along a length direction of the lower fixing part.

13. The solar panel tilt support member of claim 12, wherein an outer surface of the fastening panel part is provided with a plurality of second reinforcing ribs which are formed by protruding along a vertical direction to prevent the fastening panel part from bending.

14. The solar panel tilt support member of claim 4, wherein a step part in a form of an ascending staircase that becomes higher toward rearward so as to selectively support the upper transverse support frame at different heights is formed at the rear end part of the inclined support part, and
wherein in each step part, an upper bolt additional hole is further formed to allow an upper bolt to penetrate through, and a lower additional bolt hole is further formed corresponding to an upper bolt hole additionally formed in the step part.

15. The solar panel tilt support member of claim 14, wherein an upper surface of the stepped part is formed as a surface more steeply inclined than an upper surface of the inclined support part, and when a plurality of step parts are formed, a step part formed rearward is formed as a surface more steeply inclined than a step part formed forward, so as to correspond to a changed inclination angle of the solar panel.

16. A floating solar power generation apparatus comprising:
a solar panel;
a solar panel tilt support member of claim 1 configured to support the solar panel in an inclined orientation;
a profile assembly configured to support the solar panel and the solar panel tilt support member; and
a float configured to support the profile assembly to be positioned above a water surface.
